(19) United States
(12) Patent Application Publication
(10) Pub. No.: US 2010/0207875 A1
(43) Pub. Date: Aug. 19, 2010

(54) COMMAND CONTROL SYSTEM AND METHOD THEREOF

(76) Inventor: Shih-Ping Yeh, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/699,057

(22) Filed: Feb. 3, 2010

(30) Foreign Application Priority Data
Feb. 19, 2009 (TW) 098105242

(51) Int. Cl. G09G 5/00; G10L 21/00

(52) U.S. Cl. 345/156; 704/270; 704/E21.001

(57) ABSTRACT

The invention discloses a command control system including a light emitting unit, an image capturing unit, a storage unit, and a processing unit. The processing unit is coupled with the image capture unit and the storage unit. The light emitting unit emits light to form an illumination area. The image capture unit captures a plurality of pieces of image information in the illumination area. The storage unit stores different commands corresponding to the image information. The processing unit performs functions according to the commands corresponding to the image information.

### BACKGROUND OF THE INVENTION

1. Field of the Invention

The invention relates to a command control system and a method thereof and, more particularly, to a command control system and a method thereof that utilizing image and/or voice recognition

2. Description of the Related Art

Computer systems are now become “must-have” devices in the most families in the current generation. Generally speaking, when operating a computer, a direct-contacting type of a peripheral input device such as a keyboard, a mouse, or a remote controller is used to input a command to be executed. If the peripheral input device cannot be used, the command cannot be sent to the computer.

Recently, the image recognition technology and voice recognition technology are gradually mature, and non-contact technology such as the image recognition and the voice recognition are wildly used in many advanced computers for sending out the command. For the image recognition technology, the user only needs to make some gestures in front of a camera, and different commands can be sent out to operate the computer. For the voice recognition technology, the user only needs to pronounce some specific voice in a voice receiving range of a microphone, and different commands can be sent out to operate the computer.

However, image processing and voice processing have their limitations, particularly at recognizing. For example, the voice recognition is limited by noise interference caused by a noisy environment, and the image recognition is limited by the image resolution, a complex background and so on. Therefore, reference information is not enough. Additionally, the user has more chances to use a computer in different environments now. When the user utilizes the image recognition to input the command in a place with inadequate light, the camera cannot capture an image clear enough. Thus, the recognition fails, or a wrong command is executed.

### BRIEF SUMMARY OF THE INVENTION

A command control system according to the invention includes a light emitting unit, an image capture unit, a storage unit, and a processing unit. The processing unit is coupled with the image capture unit and the storage unit. The light emitting unit emits light to form an illumination area. The image capture unit captures a plurality of pieces of image information in the illumination area. The storage unit stores different commands corresponding to the image information. The processing unit performs functions according to the commands corresponding to the image information.

Since the image capture unit captures the image information in the illumination area of the light emitting unit, the processing unit can accurately recognize the captured image information in an environment with adequate brightness information to perform the corresponding command.

Additionally, according to an embodiment of the invention, the command control system further includes a voice capture unit. The voice capture unit is coupled with the processing unit to capture a plurality of voice signals. The storage unit may stores different commands corresponding to the voice signals. The processing unit performs functions according to the commands corresponding to the voice signals.

In other words, only when the voice signal are pronounced by the user and the corresponding image information are recognized to be correct, the corresponding command is performed. As a result, it can further ensure that the command would not be executed incorrectly due to interference from external factors.

A command control method according to the invention includes the following steps. First, light is emitted to form an illumination area. Second, a plurality of pieces of image information in the illumination area is captured. Third, functions are performed according to commands corresponding to the image information.

Additionally, according to an embodiment of the invention, the command control method further includes the following steps. First, a plurality of voice signals are captured. Second, the functions are performed according to commands corresponding to the voice signals.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a command control system according to a first embodiment of the invention;

FIG. 2 is a functional block diagram showing an electronic device in FIG. 1;

FIG. 3 is a schematic diagram showing a comparison table in FIG. 2;

FIG. 4 is a flow chart showing a command control method according to an embodiment of the invention;

FIG. 5 is a schematic diagram showing a command control system according to a second embodiment of the invention;

FIG. 6 is a function block diagram showing an electronic device in FIG. 5;

FIG. 7 is a schematic diagram showing a comparison table in FIG. 6;

FIG. 8 is a flow chart showing a command control method according to a second embodiment of the invention;

FIG. 9 is a schematic diagram showing a command control system according to a third embodiment of the invention; and

FIG. 10 is a schematic diagram showing a command control system according to a fourth embodiment of the invention.

### DETAILED DESCRIPTION OF THE EMBODIMENTS

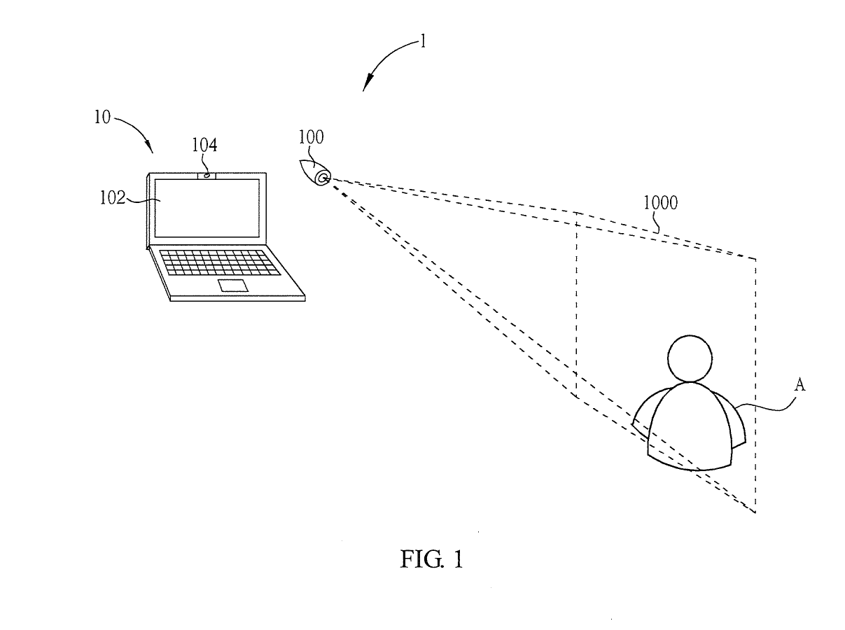

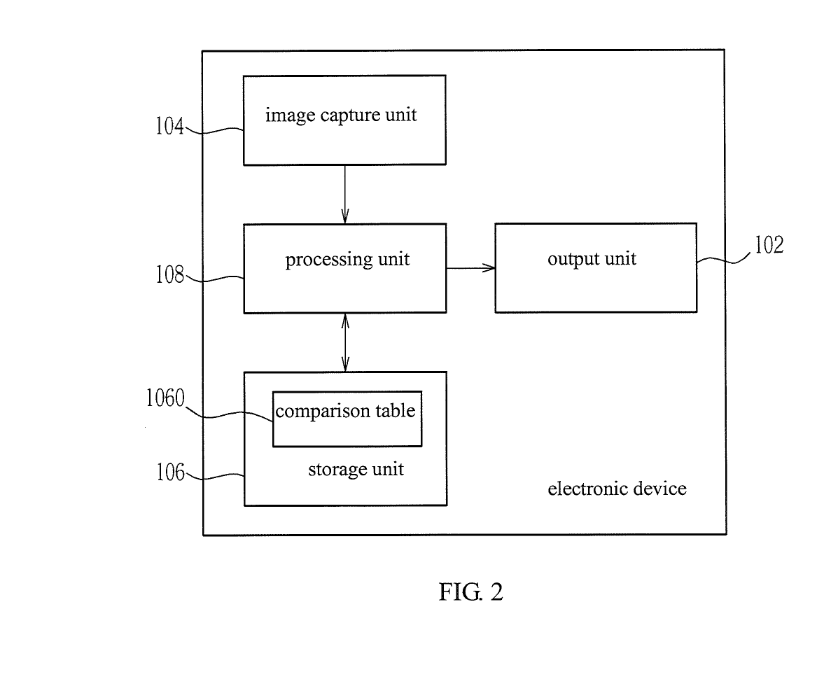

FIG. 1 is a schematic diagram showing a command control system 1 according to a first embodiment of the invention. FIG. 2 is a functional block diagram showing an electronic device 10 in FIG. 1. As shown in FIG. 1 and FIG. 2, the command control system 1 includes the electronic device 10 and a light emitting unit 100. The electronic device 10 includes an output unit 102, an image capture unit 104, a storage unit 106, and a processing unit 108. The processing unit 108 is coupled with the output unit 102, the image capture unit 104, and the storage unit 106, respectively.

The light emitting unit 100 is a light source which can emit light such as a light-emitting diode (LED). The output unit 102 may be a monitor or a loudspeaker, which depends on the kind of an output signal which may be an image signal or a voice signal, and it is not limited to the monitor as shown in FIG. 1. The storage unit 106 may be a hard disk or other storage medium. The processing unit 108 may be a processing unit such as a central processing unit (CPU) with a computing function. The image capture unit 104 may be a charge-coupled device (CCD) camera, a complementary metal-oxide-semiconductor (CMOS) camera, or one of other active pixel sensors. The image capture unit 104 is an embedded unit disposed in the electronic unit 10. However, the image capture unit 104 may be wiredly or wirelessly connected with the electronic device 10 in other embodiments, which depends on practical conditions.

The electronic device 10 shown in FIG. 1 is a notebook computer, but the invention is not limited thereto. In other words, the electronic device 10 may be one of other devices with a command executing and controlling function such as a desktop computer and a computer with a data processing function. Generally speaking, besides the components as stated above, the electronic device 10 usually includes necessary software and hardware components in operating such as a basic input and output system (BIOS), a random access memory (RAM), a read only memory (ROM), a main board (MB), a power supply, a back light module, and an operation system (OS), which depends on practical usage. The functions and structures of the components as stated above may be easily obtained and used by persons having ordinary skill in the art, and they are not described herein for a concise purpose.

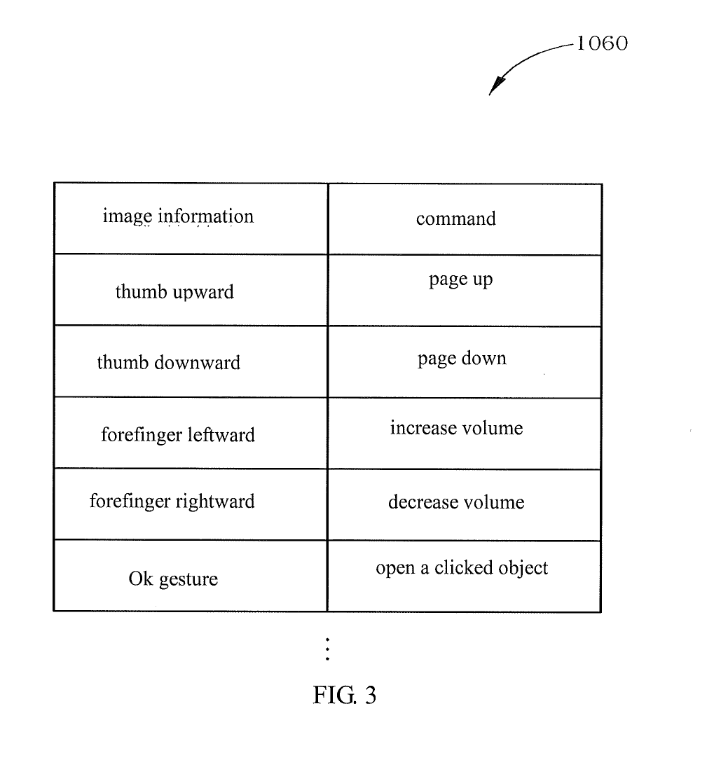

As shown in FIG. 2, the storage unit 106 is used for storing a comparison table 1060. FIG. 3 is a schematic diagram showing the comparison table 1060 in FIG. 2. As shown in FIG. 3, the comparison table 1060 records a plurality of pieces of image information and commands corresponding to the image information. The image information may be images including specific gestures and motions and so on. The command corresponding to specific image information may be set by the user himself according to his habit, and it is not limited to the mode as shown in FIG. 3. Additionally, the image information is not limited to a static image. That is, the image information may be a dynamic image. For example, the user may set that the image information of “waving a finger or a palm from right to left” corresponds to the command of “page down”. As a result, different users can design the personalized comparison table 1060 according to personal use habit, and the operation is more convenient.

As shown in FIG. 1, the light emitting unit 100 emits light to form an illumination area 1000. The light emitting unit 100 may project the light on a projection plane such as a wall or a screen in practical usage. At the time, if a command control function of the electronic device 10 is enabled, a user A may make one or more gestures in the illumination area 1000 such as moving a thumb upward or downward to be taken as the image information to control the command. Then, the image capture unit 104 captures the image information relating to the gestures made by the user A in the illumination area 1000, and it transmits the captured image information to the processing unit 108. If the gesture made by the user A is a static gesture, the image information transmitted to the processing unit 108 by the image capture unit 104 is a corresponding static image. On the contrary, if the gesture made by the user A is a dynamic gesture, the image information transmitted to the processing unit 108 by the image capture unit 104 is a corresponding dynamic image composed of a group of successive images.

Next, the processing unit 108 recognizes the gesture made by the user A according to the image information transmitted from the image capture unit 104. The storage unit 106 may pre-store application software relating to image recognition technology therein. In other words, the processing unit 108 may utilize the application software stored in the storage unit 106 to recognize the image. Since the image recognition technology may be easily obtained and used by persons having ordinary skill in the art, it is not described herein for a concise purpose.

After the gesture made by the user A is recognized, the processing unit 108 finds the command corresponding to the image information according to the comparison table 1060 and controls the output unit 102 to execute the command. For example, as shown in FIG. 3, if the gesture made by the user is “thumb upward”, the command corresponding to the image information is “page up”. Additionally, the user may set specific image information to enable or disable the command control function. For example, the user may set the image information of “opening a palm” to enable the command control function and set the image information of “make a fist” to disable the command control function.

The light emitting unit 100 first emits light to form the illumination area 1000, and then the user A makes the gesture corresponding to a control command in the illumination area 1000. Therefore, the brightness information of the image captured by the image capture unit 104 is enough to allow the processing unit 108 to accurately recognize the gesture made by the user A via the captured image information, and thus the corresponding command is executed. In other words, even if the user A uses the command control system 1 in a place with inadequate light, the definition of the image information captured by the image capture unit 104 is increased via the illumination area 1000 formed by the light emitting unit 100 to improve a success rate of the image recognition.

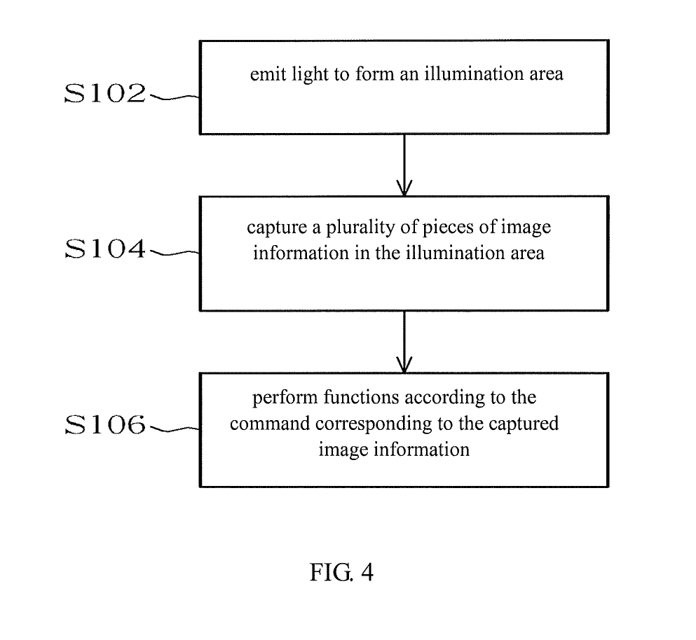

FIG. 4 is a flow chart showing a command control method according to an embodiment of the invention. Cooperating with the command control system as shown in FIG. 1 to FIG. 3, the command control method includes the following steps.

At step S102, the light is emitted to form the illumination area 1000.

At step S104, a plurality of pieces of image information in the illumination area 1000 is captured.

At step S106, the functions are performed according to the commands corresponding to the captured image information.

Control logic in FIG. 4 may be performed in the computer such as the notebook computer, the desktop computer, and the computer with the data performing function. Different parts or the functions in the control logic may be realized via software, hardware, or a combination of the software and hardware. Additionally, the control logic in FIG. 4 may be embodied via the data stored in the readable storage medium, and the readable storage medium may be a floppy disk, the hard disk, an optical disk, or one of other magnetic devices, optical devices, or a combination of magnetic and optical devices. The data representing the command stored by the readable storage medium of the computer may be performed by the computer to generate a control instruction, and then the user is allowed to utilize the gesture to execute the command.

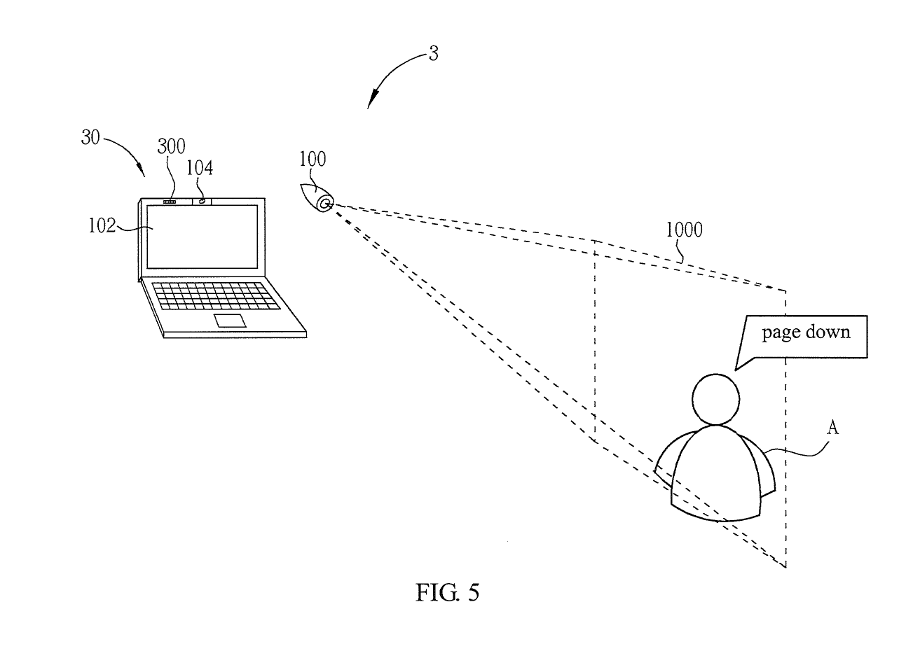

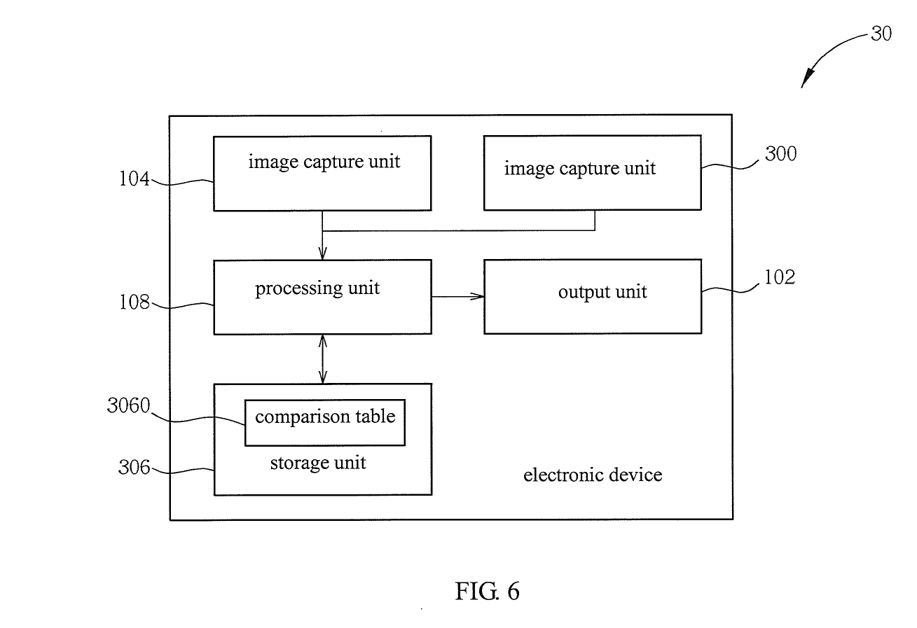

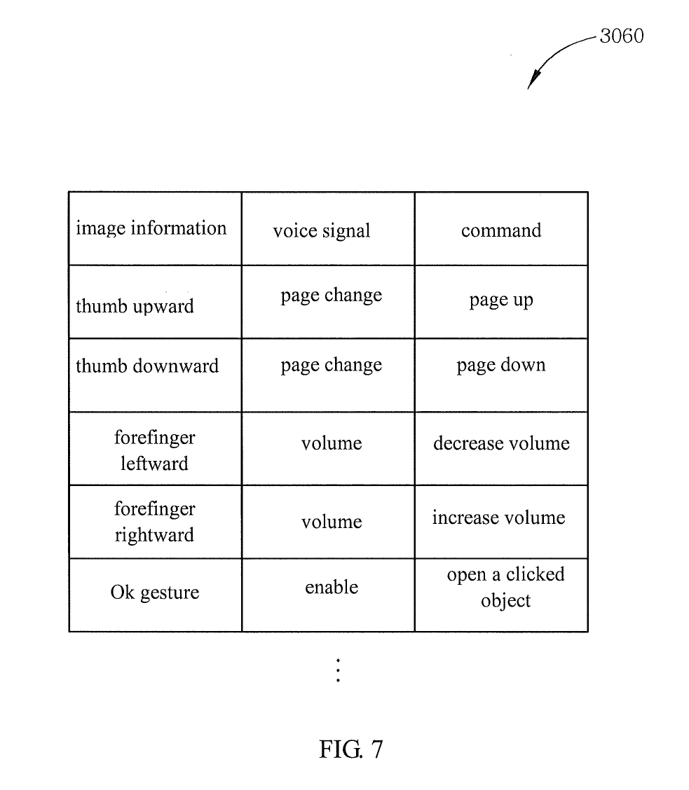

FIG. 5 is a schematic diagram showing a command control system 3 according to a second embodiment of the invention. FIG. 6 is a functional block diagram showing an electronic device 30 in FIG. 5. FIG. 7 is a schematic diagram showing a comparison table 3060 in FIG. 6. The main difference between the command control system 3 and the command control system 1 is that the electronic device 30 of the command control system 3 further includes a voice capture unit 300, and the comparison table 3060 stored in a storage unit 306 is shown in FIG. 7. The functions of the light emitting unit 100, the output unit 102, the image capture unit 104, and the processing unit 108 are the same as those of the components with the same component numbers in FIG. 1 and FIG. 2, and they are not described herein for a concise purpose.

As shown in FIG. 6, the voice capture unit 300 is coupled with the processing unit 108. The voice capture unit 300 may be an electronic device which can capture voice signals such as a microphone. The voice capture unit 300 in FIG. 6 is an embedded unit disposed in the electronic device 30. However, the voice capture unit 300 may be externally connected with the electronic device 30 wiredly or wirelessly in another embodiment, which depends on the practical usage.

As shown in FIG. 7, the comparison table 3060 records a plurality of pieces of image information, a plurality of voice signals, and the commands corresponding to the image information and the voice signals. The user himself may set the command corresponding to a piece of specific image information and a specific voice signal according to his use habit, which is not limited to examples shown in FIG. 7. Additionally, the image information is not limited to the static image. That is, the image information may be the dynamic image. Furthermore, the voice signal may include a word or a sentence. As a result, different users themselves may design the personalized comparison table 3060 according to his use habit, and thus the operation is more convenient. As shown in FIG. 7, one voice signal may correspond to a plurality of pieces of different image information at the same time to control the different commands. Similarly, a piece of the image information may correspond to a plurality of different voice signals at the same time to control the different commands.

As shown in FIG. 5, if the command control function of the electronic device 30 is enabled, the user A may make the gesture such as making a thumb up in the illumination area 1000 and pronounce the corresponding voice signal such as a voice of page change to be taken as the image information and the voice signal of the control command. Then, the image capture unit 104 captures the image information relating to the gesture made by the user A in the illumination area 1000 and transmits the captured image information to the processing unit 108. At the same time, the voice capture unit 300 captures the voice signal pronounced by the user A and transmits the captured voice signal to the processing unit 108.

Next, the processing unit 108 recognizes the gesture made by the user A according to the image information transmitted from the image capture unit 104, and it recognizes the voice signal pronounced by the user A according to the voice signal transmitted from the voice capture unit 300. The storage unit 306 may pre-store the application software relating to the image recognition technology and the voice recognition technology. In other words, the processing unit 108 may utilize the application software stored in the storage unit 306 to recognize the image and the voice. Since the image recognition technology and the voice recognition technology may be easily obtained and used by persons having ordinary skill in the art, they are not described herein for a concise purpose.

After the gesture made by the user A and the voice signal pronounced by the user A are recognized, the processing unit 108 finds the command corresponding to the image information and the voice signal according to the comparison table 3060 and control the output unit 102 to perform the command. For example, if the gesture made by the user is “thumb upward” and the pronounced voice signal is “page change”, the command corresponding to the image information and the voice signal is “page up” as shown in FIG. 7. Additionally, the user may set a piece of specific image information and a specific voice signal to enable or disable the command control function. For example, the user may set the image information of “opening a palm” and the voice signal of “enable” to enable the command control function, and he may set the image information of “make a fist” and the voice signal of “disable” to disable the command control function.

Consequently, only when the voice signal pronounced by the user and the corresponding image information are recognized to be correct, the corresponding command is executed. As a result, it can further ensure that the command would not be executed incorrectly due to interference from external factors.

Additionally, the user may set an actuating image to correspond to the command actuating the voice capture unit 300. Only after the actuating image appears, the voice capture unit 300 is actuated. In other words, before the actuating image appears, the voice capture unit 300 is turned off, and it cannot capture the voice signal pronounced by the user.

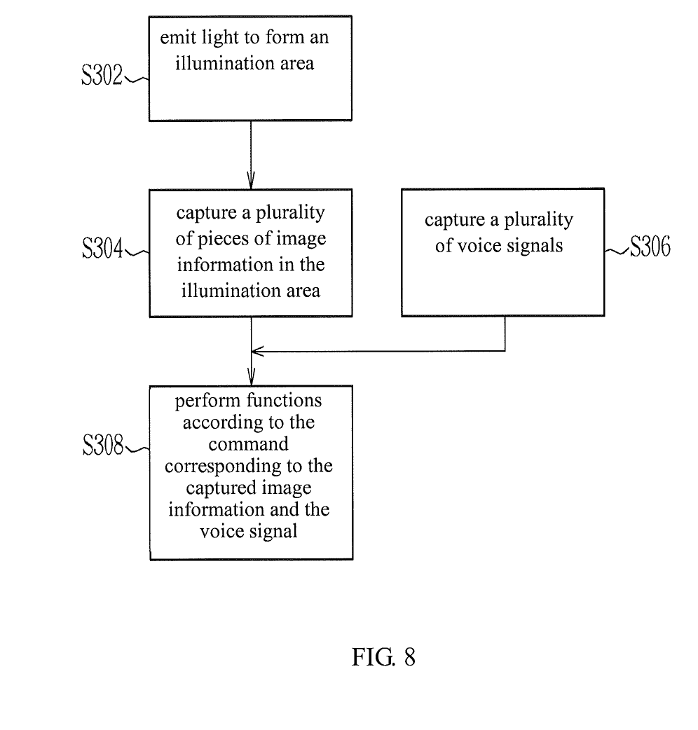

FIG. 8 is a flow chart showing a command control method according to a second embodiment of the invention. Cooperating with the command control system 3 in FIG. 5 to FIG. 7, this command control method includes the following steps.

At step S302, the light is emitted to form the illumination area 1000.

At step S304, a plurality of pieces of image information is captured in the illumination area 1000.

At step S306, a plurality of voice signals are captured.

At step S308, the functions are performed according to the command corresponding to the captured image information and the voice signal.

The control logic in FIG. 8 similar to the control logic in FIG. 4 may be realized by the software, the hardware, or a combination of the software and hardware.

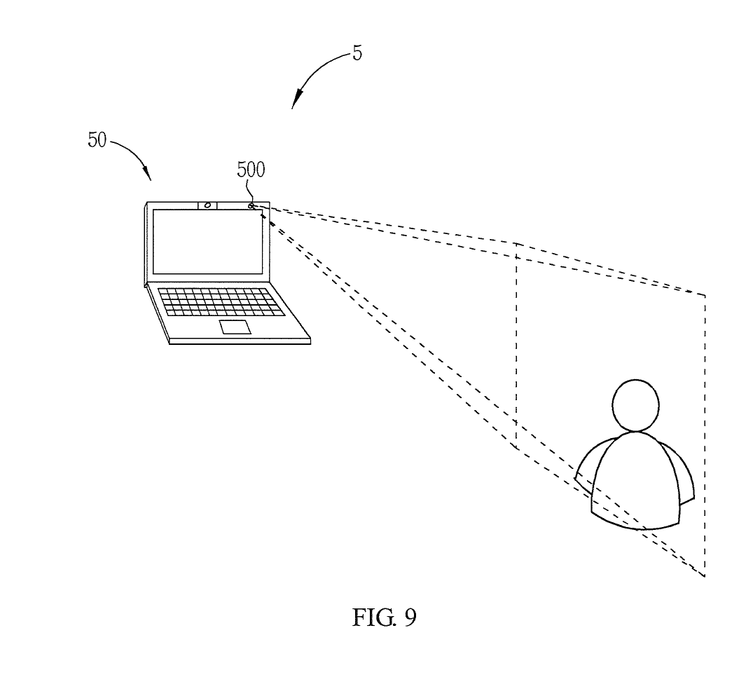

FIG. 9 is a schematic diagram showing a command control system 5 according to a third embodiment of the invention. The main difference between the command control system 5 and the command control system 1 is that the light emitting unit 500 of the command control system 5 is the embedded unit disposed in the electronic device 50. An operation principle of the command control system 5 in FIG. 9 is almost the same as the command control system 1 in FIG. 1, and it is not described herein for a concise purpose.

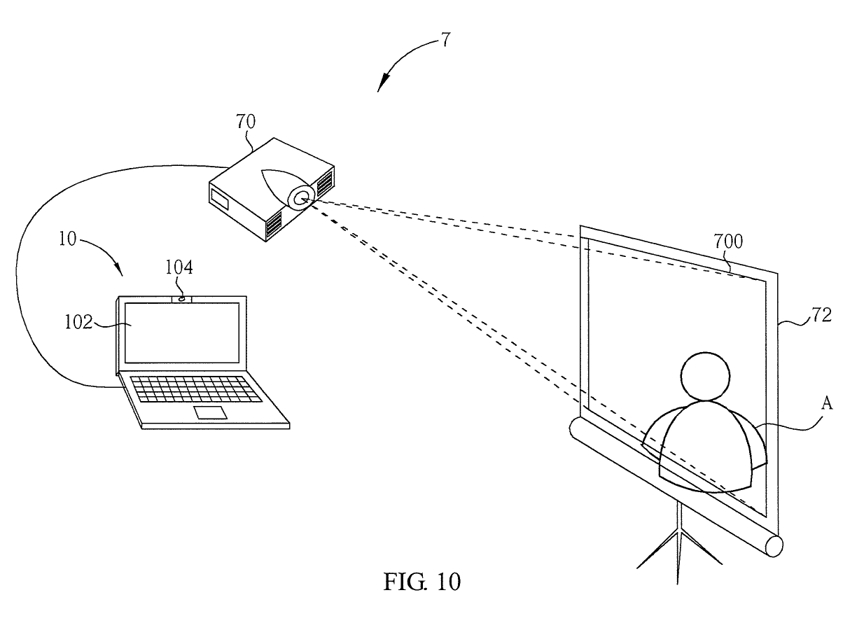

FIG. 10 is a schematic diagram showing a command control system 7 according to a fourth embodiment of the invention. The command control system 7 according to the invention may be used at a presentation conference in practical usage. The main difference between the command control system 7 and the command control system 1 is that the command control system 7 utilizes the light projected by a projector 70 to replace the light emitting unit 100 in FIG. 1 as the light source.

As shown in FIG. 10, the projector 70 projects a projection picture 700 on a screen 72. The screen 72 may be replaced by one of any other projection surfaces such as the wall. The projector 70 is electrically connected with the electronic device 10 to make the projection picture 700 of the projector 70 and the picture displayed on the output unit 102 of the electronic device 10 displayed synchronous. The projection picture 700 is the illumination area 1000 in FIG. 1 in this embodiment. When the user A utilizes the image information to input the control command, he only needs to make the gesture or make a specific motion in an illumination range of the projection picture 700, and the image capture unit 104 can capture the image with enough brightness information to be used in the subsequent image recognition. As a result, the user A may easily input the control command during the briefing meeting by utilizing the change of the image information. The operation principle of the command control system 7 in FIG. 10 is almost the same as that of the command control system 1 in FIG. 1, and it is not described herein for a concise purpose.

Additionally, the electronic device 30 in FIG. 5 may be utilized to perform the briefing meeting. In other words, during the briefing meeting, the voice recognition technology may be added to prevent operation accidentally caused by the gesture made in the projection picture 700 by the user A by mistake. Therefore, only when the voice signal pronounced by the user A and the corresponding image information are recognized to be correct, the corresponding command is executed.

In contrast with conventional technology, in the invention, the light emitting unit first emits light to form the illumination area, and the user makes the gesture corresponding to the control command in the range of the illumination area. Therefore, the brightness information of the image captured by the image capture unit is adequate enough to allow the processing unit to accurately recognize the gesture made by the user from the captured image information, and thus the corresponding command is executed. Additionally, the specific command may correspond to both the image information and the voice signal. Therefore, only when the voice signal pronounced by the user and the corresponding image information are recognized to be correct, the corresponding command is executed. As a result, it can further ensure that the command would not be executed incorrectly due to the interference from the external factors.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A command control system, comprising:
a light emitting unit for emitting light to define an illumination area;
an image capture unit for capturing image information in the illumination area;
a storage unit for storing different commands corresponding to the image information; and
a processing unit coupled with the storage unit and the image capture unit for executing the commands corresponding to the image information.

2. The command control system according to claim 1, further comprising a voice capture unit coupled with the processing unit to capture a plurality of voice signals.

3. The command control system according to claim 2, wherein the storage unit stores different commands corresponding to the voice signals.

4. The command control system according to claim 3, wherein the processing unit performs functions according to the commands corresponding to the voice signals.

5. The command control system according to claim 2, wherein the image information comprises an actuating image.

6. The command control system according to claim 5, wherein the voice capture unit is actuated after the actuating image appears.

7. The command control system according to claim 2, wherein the voice capture unit is a microphone.

8. The command control system according to claim 2, wherein the voice signals comprises a word or a sentence.

9. The command control system according to claim 1, wherein the image information comprises a static image or a dynamic image.

10. A command control method, comprising:
emitting light to define an illumination area;
capturing image information in the illumination area; and
executing commands corresponding to the captured image information.

11. The command control method according to claim 10, further comprising:
capturing a plurality of voice signals; and
executing commands corresponding to the voice signals.

12. The command control method according to claim 11, wherein the voice signals comprises a word or a sentence.

13. The command control method according to claim 10, comprising:
actuating a voice capture unit after an actuating image of the image information appears.

14. The command control method according to claim 10, wherein the image information comprises a static image or a dynamic image.
